(19) United States
(12) Patent Application Publication
(10) Pub. No.: US 2014/0183988 A1
(43) Pub. Date: Jul. 3, 2014

(54) Assemblies For Cooling Electric Machines

(71) Applicant: TECO-Westinghouse Motor Company, Round Rock, TX (US)

(72) Inventors: Devdatta P. Kulkarni, Austin, TX (US); Gabriel Rupertus, Austin, TX (US); Edward Chen, Austin, TX (US); Lex Ramsey, Austin, TX (US)

(73) Assignee: TECO-Westinghouse Motor Company, Round Rock, TX (US)

(21) Appl. No.: 13/790,944

(22) Filed: Mar. 8, 2013

Related U.S. Application Data
(60) Provisional application No. 61/747,874, filed on Dec. 31, 2012.

(51) Int. Cl. H02K 9/19

(52) U.S. Cl. CPC H02K 9/19
USPC 310/54

(57) ABSTRACT

Cooling assemblies (e.g., tubes, members (e.g., i-beams, rectangular members, and the like), stator windings, stator laminations, and/or combinations thereof), such as those configured to cool electric machines (e.g., electric motors and generators).

### CROSS-REFERENCE TO RELATED APPLICATIONS

This application claims priority to U.S. Provisional Patent Application No. 61/747,874, filed Dec. 31, 2012, which is incorporated by reference in its entirety.

### BACKGROUND

1. Field of the Invention

The present invention relates generally to cooling assemblies, and more particularly, but not by way of limitation, to cooling assemblies configured to cool electric machines.

2. Description of Related Art

Examples of cooling assemblies are shown in, for example, U.S. Pat. Nos. 4,117,358; 7,545,060; and 8,040,000 and U.S. Patent Publication Nos. 2005/0067904; 2011/0221287; and 2011/0278968.

### SUMMARY

This disclosure includes embodiments of cooling assemblies that are configured to cool electric machines, such as electric motors and generators.

Some embodiments of the present cooling assemblies comprise a stator core comprising a plurality of laminations and having a first end, a second end, and a bore extending from the first end to the second end and configured to accommodate at least a portion of a rotor; a plurality of members disposed between at least two adjacent laminations such that the at least two adjacent laminations form at least one channel that extends at least partially around the stator core; and at least one tube disposed in the at least one channel and configured to permit fluid to move through the at least one tube.

Some embodiments of the present cooling assemblies comprise a stator core comprising a plurality of laminations and having a first end, a second end, and a bore extending from the first end to the second end and configured to accommodate a at least a portion of rotor; a plurality of members disposed between a plurality of adjacent laminations such that each of the plurality of adjacent laminations forms a channel that extends at least partially around the stator core; and a tube disposed in the channel formed by each of the plurality of adjacent laminations, the tube configured to permit fluid to move through the tube.

The term “coupled” is defined as connected, although not necessarily directly, and not necessarily mechanically. Two items are “couplable” if they can be coupled to each other. Unless the context explicitly requires otherwise, items that are couplable are also decouplable, and vice-versa. One non-limiting way in which a first structure is couplable to a second structure is for the first structure to be configured to be coupled (or configured to be couplable) to the second structure. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a cooling assembly, or a component of a cooling assembly, that “comprises,” “has,” “includes” or “contains” one or more elements or features possesses those one or more elements or features, but is not limited to possessing only those elements or features. Likewise, a method that “comprises,” “has,” “includes” or “contains” one or more steps possesses those one or more steps, but is not limited to possessing only those one or more steps. Additionally, terms such as “first” and “second” are used only to differentiate structures or features, and not to limit the different structures or features to a particular order.

Any embodiment of any of the present cooling assemblies can consist of or consist essentially of—rather than comprise/include/contain/have—any of the described elements and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures illustrate at least one of the described elements using a graphical symbol that will be understood by those of ordinary skill in the art. The embodiments of the present cooling assemblies and their components shown in the figures are drawn to scale for at least the embodiments shown.

FIG. 1 depicts a perspective view of one embodiment of the present cooling assemblies.

FIG. 2 depicts a perspective, cross-sectional view of a portion of the cooling assembly of FIG. 1; cross-hatching has not been used.

FIG. 3 depicts a front, cross-sectional view of a portion of the cooling assembly of FIG. 1; cross-hatching has not been used.

FIG. 4 depicts a detailed view of a portion of the cooling assembly of FIG. 1.

FIGS. 5A-5B depict perspective views of the cooling assembly of FIG. 1 disposed in and coupled to a casing.

### DESCRIPTION OF ILLUSTRATIVE EMBODIMENTS

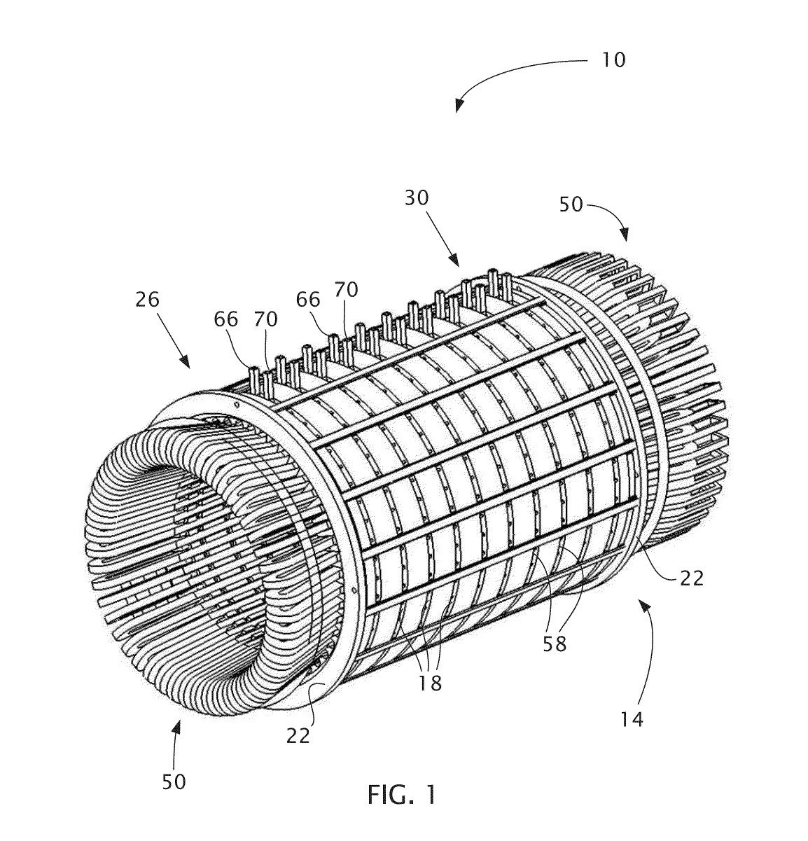

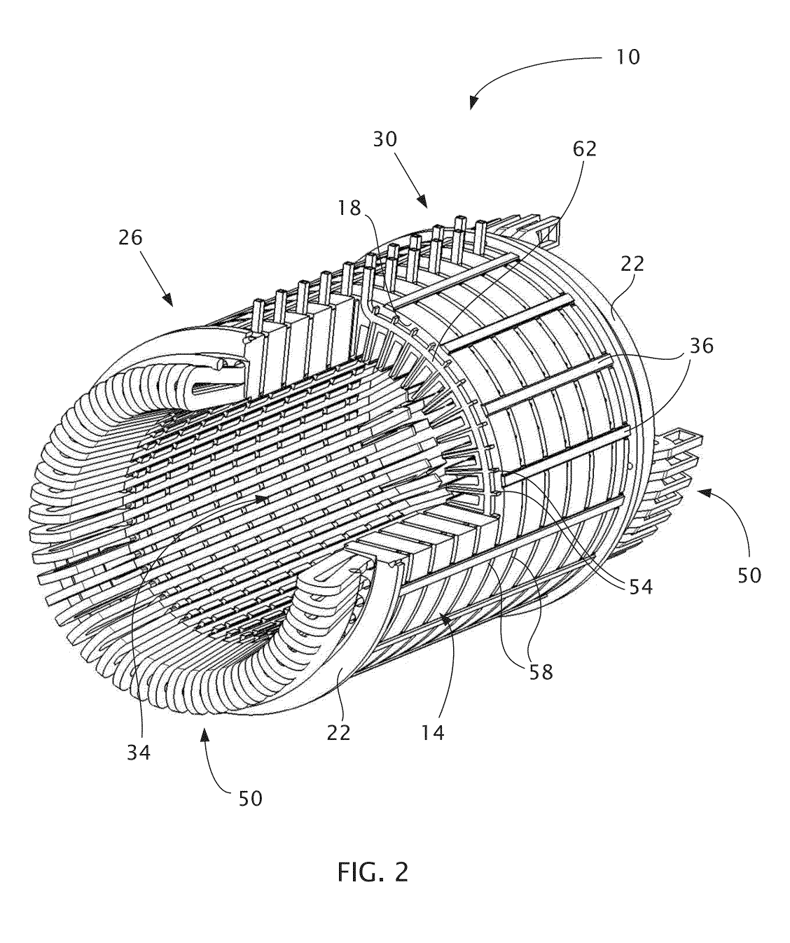

Referring now to the drawings, and more particularly to FIGS. 1-5B, is cooling assembly 10, one embodiment of the present cooling assemblies. Cooling assembly 10 is configured to increase power density of an electric machine from the power density the machine would have without it by, for example, lowering an operating temperature of the electric machine to permit the machine to operate at a higher power level without overheating. As another example, cooling assembly 10 can cool an electric machine without a cooling jacket, thus potentially: decreasing weight and/or size of the electric machine and reducing or eliminating issues relating to the high shrink fit pressure of a jacket frame; eliminating the need to machine a stator outer diameter and jacket inner diameter that optimizes fluid cooling performance, and the like; though in some embodiments, a cooling jacket can cooperate with cooling assembly 10 to provide additional cooling, if desired, to an electric machine.

In the embodiment shown, cooling assembly 10 comprises stator core 14, which has a plurality of laminations 18. Laminations 18 are not shown individually, but are depicted in an assembled configuration (e.g., stacked in groups of laminations 18). Each lamination 18 in the plurality can be coupled to adjacent laminations—such as by riveting, bolting, welding, bonding, brazing, dimpling, or the like—and/or can be prevented from moving away from adjacent laminations by one or more end plates 22 (specifically, two end plates 22, in the embodiment shown). Each lamination 18 can comprise various materials, including, for example, silicon steel, carbon steel, cold rolled steel, nickel alloys, cobalt alloys, and the like. In the embodiment shown, stator core 14 has first end 26, second end 30, and bore 34. Bore 34 extends from first end 26 to second end 30 and is configured to accommodate at least a portion of a rotor. That configuration can be achieved through, for example, a substantially cylindrical configuration as depicted in the embodiment shown. In the embodiment shown, stator core 14 also comprises a plurality of cross bars 36 that each extends longitudinally with respect to stator core 14 (and is parallel to bore 34) and is coupled to at least some of laminations 18 and/or end plates 22.

In the embodiment shown, stator core 14 (and, more specifically, each lamination 18) comprises a plurality of teeth 38 extending toward bore 34 of stator core 14, any two of which are respectively at least partially separated from each other by an opening 42. In the embodiment shown, assembly 10 further comprises windings 46 respectively disposed in openings 42 such that each winding 46 is disposed between adjacent teeth 38. Each winding 46 comprises a winding end turn 50 and can be disposed between and/or be coupled to adjacent teeth 38 in any suitable manner, including, for example, by injection. Further, each winding 46 can comprise any suitable material, including copper, aluminum, alloys thereof, and the like.

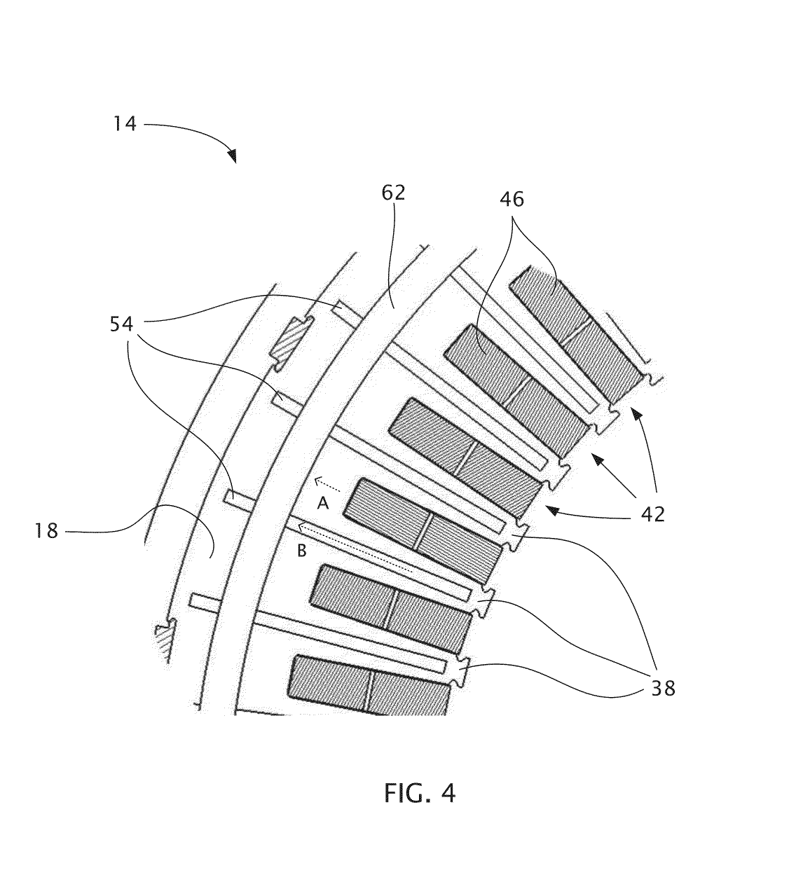

In the embodiment shown, cooling assembly 10 further comprises members 54, one of which (up to each of which) can be disposed between (and, for example, in contact with) at least two adjacent laminations 18 such that the adjacent laminations form at least one channel 58 extending at least partially around stator core 14. In the embodiment shown, one member 54 is disposed between adjacent groups of laminations 18 to form channels 58 extending at least partially around stator core 14 (e.g., ten channels, in the embodiment shown). In being so disposed, at least some members 54 extend between adjacent windings 46. In the embodiment shown, channels 58 are substantially equidistant from one another; in other embodiments, they are not. Similarly, between adjacent groups of laminations 18, each member 54 is substantially equidistant from adjacent members 54 in a respective channel; in other embodiments, each member 54 is not. Each member 54 can comprise any suitable shape, such as, for example, a substantially rectangular shape, as depicted in FIG. 4, a substantially square shape, a substantially cylindrical shape, an i-beam, and the like. Further, each member 54 can comprise any suitable thermally conductive material, such as copper, aluminum, steel, alloys thereof, and similar thermally conductive materials. In other embodiments, members 54 do not comprise a thermally conductive material.

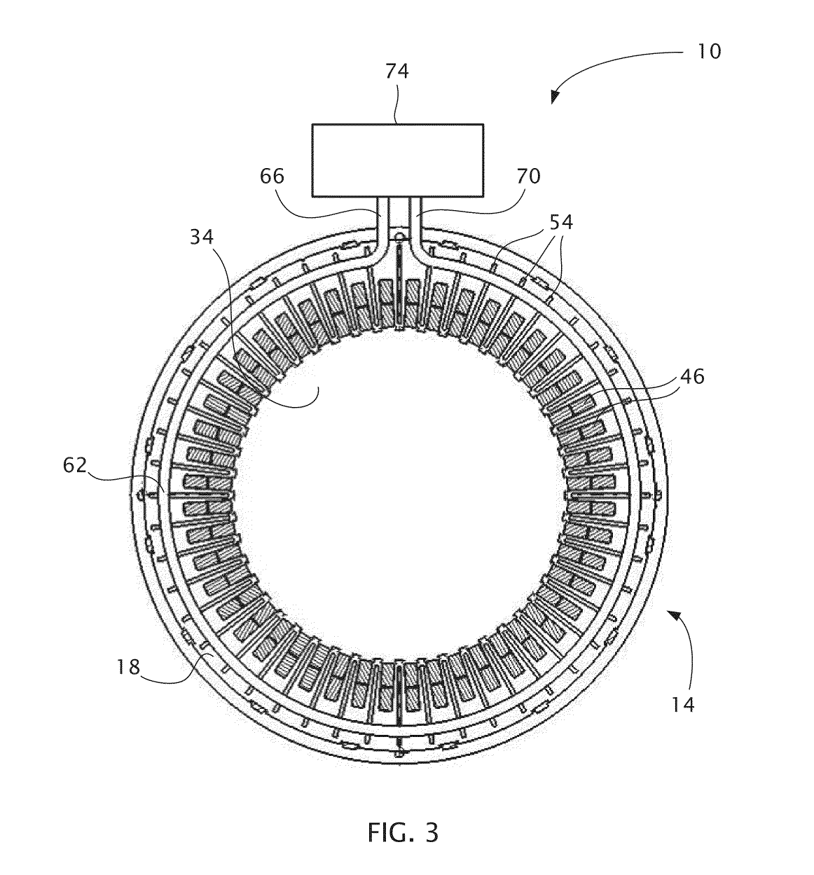

Assembly 10 can further comprise at least one tube, such as tube 62 shown in FIGS. 3-4. In the embodiment shown, assembly 10 comprises tubes 62 (e.g., five, ten, fifteen, twenty, or more tubes 62). Each tube 62 is disposed in a channel 58 and extends around at least a majority of stator core 14. Each tube 62 is configured to permit fluid (e.g., single- or two-phase fluids) to move through the tube. Such fluid (and fluid mixtures) can include, for example, gas (e.g., air), liquid (e.g., water), refrigerants (e.g., R-134a and R-22), dielectric and high dielectric fluids (e.g., glycol/water mixtures, polyalphaolefin (PAO), 3M™ Novec™ 7600), other fluids, and combinations thereof Each tube 62 comprises an inlet 66 that is configured (e.g., sized) to permit fluid to enter the tube and an outlet 70 that is configured (e.g., sized) to permit fluid to exit the tube. In the embodiment shown, each tube 62 is coupled to (e.g., held in contact with, soldered, bonded, brazed, and/or the like) the respective members 54 in the respective channel 58 in which that tube is positioned. In the embodiment shown, each tube 62 is substantially rectangular in shape; however, a given tube of the present cooling assemblies can comprise any shape that is configured to correspond to or otherwise work within the shape of the channel (e.g., channel 58) in which it is disposed—such as to maximize the surface area of the tube in contact with adjacent laminations—including, for example, square, ovular, circular, trapezoidal, and the like. As with members 54, each tube 62 can comprise any suitable thermally conductive material (e.g., copper, aluminum, steel alloys thereof, and the like). In other embodiments, the tubes do not comprise a thermally conductive material.

In the embodiment shown, assembly 10 also includes various ways of increasing thermal contact and/or conductivity between components of assembly 10, such as tubes 62, laminations 18, and/or members 54. For example, in some embodiments, thermal interface material can be disposed on at least one of tubes 62, laminations 18, and/or members 54. Thermal interface material can include, for example, thermal greases (e.g., silicone-based greases, sodium silicate-based greases, and polyethylene glycol-based greases), resilient thermal conductors (e.g., conducting particle filled elastomers), solder, thermal fluids (e.g., mineral oil), and the like. In some embodiments, thermal interface material can have a high fluidity to minimize the thickness of thermal interface material after being disposed on tubes 62, adjacent laminations 18, and/or members 54. In other embodiments, thermal interface material can have a high filler content to, for example, increase thermal contact and/or conductivity between tubes 62, laminations 18, and/or members 54. As another example, assembly 10 can comprise vacuum pressure impregnation (VPI) resin (e.g., epoxy, polyester, combinations thereof, and the like) disposed in channels 58 and configured to reduce contact resistance between tubes 62, laminations 18, and/or members 54.

In the embodiment shown, assembly 10 further comprises heat exchanger 74. Heat exchanger 74 (e.g., air to liquid, liquid to liquid, etc.) can be coupled (e.g., either directly or indirectly) to one or more inlets 66 and outlets 70 of tubes 62. Heat exchanger 74 is configured to remove heat from fluid in each of tubes 62. For example, in one embodiment, fluid (e.g., cooled gas (e.g., air), cooled liquid (e.g., water), other fluids, and combinations thereof) can enter assembly 10 via an inlet 66 of a tube 62. Fluid can move through tube 62 disposed in channel 58 around stator core 14. Heat from stator core 14 can pass into tube 62 to the fluid as depicted by Heat Pathway A in FIG. 4 (e.g., by conduction from windings 46 and/or laminations 18 directly to tube 62) and/or as depicted by Heat Pathway B in FIG. 4 (e.g., from windings 46 and/or laminations 18 indirectly to tube 62 through members 54). Fluid continues through tube 62 around stator core 14 and exits tube 62 from an outlet 70 and into heat exchanger 74 (e.g., air to liquid, liquid to liquid, etc.). Heat exchanger 74 is configured to remove heat from the fluid and recirculate fluid through inlet an 52 of a tube 62 to continue cooling stator core 14.

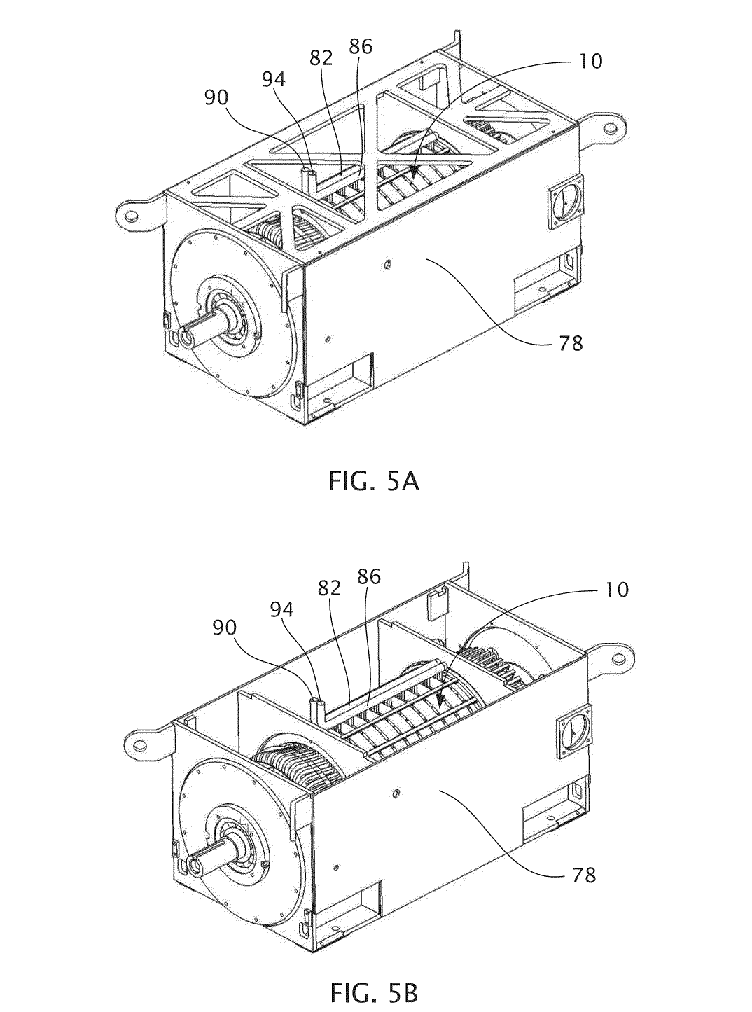

As shown in FIGS. 5A-5B, cooling assembly 10 can be at least partially disposed within casing 78. Casing 78 can have a substantially similar shape to cooling assembly 10 (e.g., cylindrical); however, in the embodiment shown, casing 78 comprises a substantially rectangular shape. In other embodiments, casing 78 can comprise any suitable shape configured to at least partially receive cooling assembly 10 (e.g., square). In the embodiment shown, casing 78 further comprises and/or is coupled to external inlet tube 82 and external outlet tube 86. External inlet and outlet tubes 82 and 86 are configured to be coupled to inlet tube 66 and outlet tube 70, respectively, and further configured to be coupled to heat exchanger 74 (e.g., if a heat exchanger is used). External inlet tube 82 comprises opening 90 configured to permit access to assembly 10 and fluid communication between inlet tube 66; and similarly, external outlet tube 86 comprises opening 94 configured to permit exit from assembly 10 and fluid communication between outlet tube 70.

As described in detail above, certain components of cooling assembly 10 (e.g., members 54 and tubes 62) can comprise various thermally conductive materials (e.g., metals and non-metals) configured to improve heat transfer through such components, including, but not limited to, steel, carbon steel, aluminum, copper, silver, gold, lead, and combinations and/or alloys thereof In other embodiments, however, certain components of cooling assembly 10 (e.g., members 54 and tubes 62) can comprise materials of lower conductivity. Further, such components can comprise thin, light weight, and/or low density materials to improve heat transfer and/or minimize weight of assembly 10.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A cooling assembly for an electric machine comprising:
a stator core comprising a plurality of laminations and having:
a first end;
a second end; and
a bore extending from the first end to the second end and configured to accommodate at least a portion of a rotor;
a plurality of members disposed between at least two adjacent laminations such that the at least two adjacent laminations form at least one channel that extends at least partially around the stator core; and
at least one tube disposed in the at least one channel and configured to permit fluid to move through the at least one tube.

2. The assembly of claim 1, further comprising:
a plurality of windings coupled to the stator core, where at least some members of the plurality of members are configured to extend between adjacent windings of the plurality of windings.

3. The assembly of claim 1, where the plurality of members are coupled to the at least one tube.

4. The assembly of claim 1, where the at least one tube extends around a majority of the stator core.

5. The assembly of claim 1, further comprising:
vacuum pressure impregnation resin disposed in the at least one channel such that contact resistance is reduced between the at least one tube, the respective adjacent laminations, and the respective plurality of members.

6. The assembly of claim 1, where the at least one tube comprises at least one of copper and aluminum.

7. The assembly of claim 1, where when a fluid moves through the at least one tube, the fluid comprises a refrigerant.

8. The assembly of claim 1, where when a fluid moves through the at least one tube, the fluid comprises a dielectric fluid.

9. The assembly of claim 1, where when a fluid moves through the at least one tube, the fluid comprises a high dielectric fluid.

10. The assembly of claim 1, further comprising:
a heat exchanger coupled to the assembly and configured to remove heat from fluid in the at least one tube.

11. A cooling assembly for an electric machine comprising:
a stator core comprising a plurality of laminations and having:
a first end;
a second end; and
a bore extending from the first end to the second end and configured to accommodate a at least a portion of rotor;
a plurality of members disposed between a plurality of adjacent laminations such that each of the plurality of adjacent laminations forms a channel that extends at least partially around the stator core; and
a tube disposed in the channel formed by each of the plurality of adjacent laminations, the tube configured to permit fluid to move through the tube.

12. The assembly of claim 11, further comprising:
a plurality of windings coupled to the stator core, where at least some members of the plurality of members are configured to extend between adjacent windings of the plurality of windings.

13. The assembly of claim 11, where the plurality of members are coupled to the respective tube.

14. The assembly of claim 11, where the tube extends around a majority of the stator core.

15. The assembly of claim 11, where the tube is in contact with the respective adjacent laminations.

16. The assembly of claim 11, further comprising:
vacuum pressure impregnation resin disposed in the channel formed by each of the plurality of adjacent laminations such that contact resistance is reduced between the respective tube, the respective adjacent laminations, and the respective plurality of members.

17. The assembly of claim 11, where when a fluid moves through the tube, the fluid comprises a refrigerant.

18. The assembly of claim 11, where when a fluid moves through the tube, the fluid comprises a dielectric fluid.

19. The assembly of claim 11, where when a fluid moves through the tube, the fluid comprises a high dielectric fluid.

20. The assembly of claim 11, further comprising:
a heat exchanger coupled to the assembly and configured to remove heat from fluid in the tube.
